(19) United States
(12) Patent Application Publication
(10) Pub. No.: US 2014/0304675 A1
(43) Pub. Date: Oct. 9, 2014

(54) ELECTRONIC ELEMENT DESIGN SYSTEM AND METHOD

(71) Applicant: HON HAI PRECISION INDUSTRY CO., LTD., New Taipei (TW)

(72) Inventor: CHUNG-LUN HSU, New Taipei (TW)

(73) Assignee: HON HAI PRECISION INDUSTRY CO., LTD., New Taipei (TW)

(21) Appl. No.: 14/228,200

(22) Filed: Mar. 27, 2014

(30) Foreign Application Priority Data
Apr. 8, 2013 (TW) 102112287

(51) Int. Cl. G06F 17/50

(52) U.S. Cl. CPC G06F 17/5081
USPC 716/136

(57) ABSTRACT

An exemplary electronic element design method includes obtaining a stored transfer function, determining electronic elements, determining information of the determined electronic elements, and obtaining the information of the electronic elements. Next, the method calculates a deviation value of the electronic element with the model number. The method then determines the model number of the electronic element having the greatest deviation value, and further determining the parameter of the electronic element with the determined model number. Next, the method inputs all the determined parameters into the obtained transfer function to generate a real value, and comparing the real value with a stored reference rule to determine whether all of the electronic elements are eligible. If yes, the method then controls a display unit to display information to prompt that all of the electronic elements are eligible.

### BACKGROUND

1. Technical Field

The present disclosure relates to electronic element design system, and particularly, to an electronic element design system capable of saving manpower and a related method.

2. Description of Related Art

Different positions in a circuit may need different types of electronic elements, thus a number of types of electronic elements are employed in the circuit. Because the precision and the manufacturing of each type of the electronic elements are different, each type of the electronic elements further includes a number of electronic elements with different model numbers. Thus, the number of the electronic elements which can be employed in one position of the circuit is huge. Usually, each model number of electronic elements may also include a number of parameters, such as temperature coefficient, initial tolerance. A common electronic element design method employs manpower to collect information of the electronic elements of the circuit. The information includes, but is not limited to, the parameters. The common electronic components design method further employs manpower to input the parameters of the electronic element corresponding to each position of the circuit into a transfer function, to generate an output value, and further determines whether the electronic elements are eligible according to the output value. However, because the number of the electronic elements which can be employed in one position of the circuit is huge, the times that input the parameters of the electronic elements are great, which is time consuming and manpower consuming. Accordingly, there is a need for an electronic element design system to resolve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device in accordance with an exemplary embodiment.

FIG. 2 is a flowchart of an electronic element design method in accordance with an exemplary embodiment.

### DETAILED DESCRIPTION

The embodiments of the present disclosure are now described in detail, with reference to the accompanying drawings.

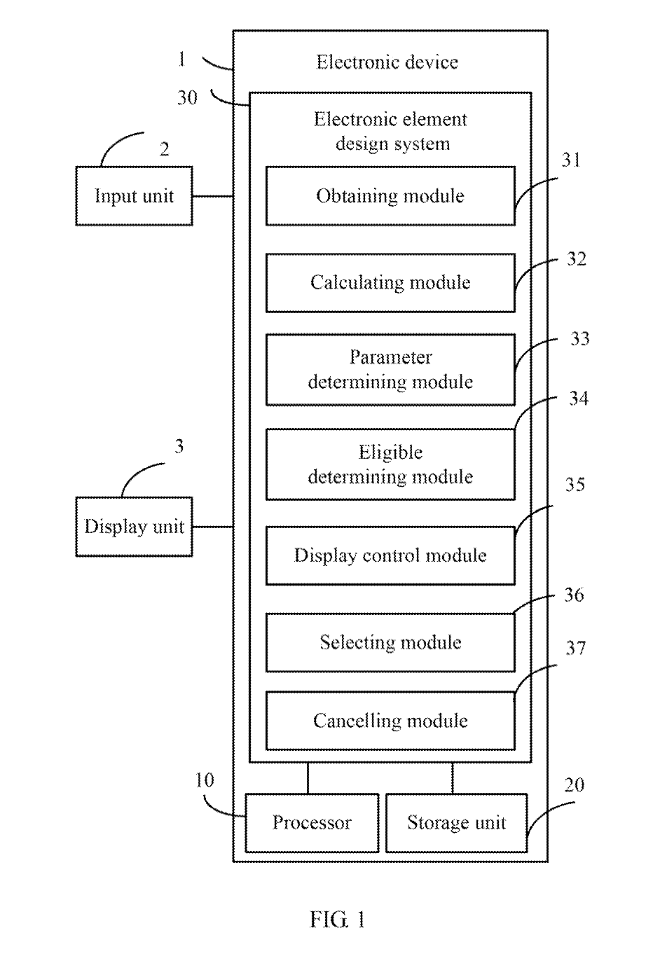

FIG. 1 shows an embodiment of an electronic device 1. The electronic device 1 determines the electronic elements capable of being employed in a circuit. In the embodiment, the electronic elements include, but are not limited to, resistors, capacitors, and inductors. Each circuit employs a number of different types of electronic elements. Each type of the electronic elements are the electronic elements with a same element value (i.e., a same resistance value, a same capacitance value, a same inductance value), and each type of the electronic elements include a number of electronic elements with different model numbers which can be vendor serial number used to identify the electronic elements. Take the resistors with 5 ohms for example, the resistors with 5 ohms includes two model numbers, for example, a model number “abc111” and a model number “opq123”. The electronic element with a model number includes a number of parameters, such as temperature coefficient, initial tolerance. The electronic device 1 is connected to an input unit 2 and a display unit 3. The electronic device 1 determines whether the electronic elements are eligible in response to user operation on the input unit 2 to generate a test result, and controls the display unit 3 to display the test result.

In the embodiment, the electronic device 1 includes a processor 10 and a storage unit 20. An electronic element design system 30 is applied on the electronic device 1. In the embodiment, the electronic element design system 30 includes an obtaining module 31, a calculating module 32, a parameter determining module 33, an eligible determining module 34, a display control module 35, a selecting module 36, and a cancelling module 37. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device. The processor 10 can be a central processing unit, a digital processor, a single chip, for example.

In the embodiment, the storage unit 20 further stores a bill of material (BOM) table. The BOM table records information of the electronic elements. In the embodiment, the information of the electronic elements includes the types of the electronic elements, the model numbers corresponding to each type of the electronic elements, and the parameters corresponding to the electronic element with each model number. The storage unit 20 further stores a number of circuit diagrams, a number of transfer functions corresponding to the circuit diagrams, and a number of reference rules corresponding to the circuit diagrams. Each circuit diagram consists of a number of electronic elements. The circuit diagrams, the transfer functions, and the reference rules are pre-stored in the storage unit 20. Each circuit diagram corresponds to one transfer function and one reference rule. The transfer function corresponds to the circuit is the prior arts and the description of the transfer function is omitted herein. A user can select the needed parameters to test a predetermined function, for example, the selecting of the parameters of the temperature coefficient and the initial tolerance represents to test the environment influence. The reference rule includes, but is not limited to, a target value, an upper threshold of the target value, and a lower threshold of the target value. The target value includes, but is not limited to, a target output voltage, a target overvoltage protection value, and a target overcurrent protection value.

The obtaining module 31 obtains a transfer function corresponding to a selected circuit diagram in response to the user operation to select the circuit diagram. The obtaining module 31 further determines the electronic elements corresponding to the selected circuit diagram, determines the information of the determined electronic elements corresponding to the selected circuit diagram in the BOM table, and obtains the information of the determined electronic elements corresponding to the selected circuit diagram and the one or more selected parameters from the BOM table in response to the user operation to select one or more parameters. The parameters of the obtained information of the determined electronic elements corresponding to the selected circuit diagram only include the selected one or more parameters.

The calculating module 32 calculates a deviation value of the electronic element with the model number according to a formula: d=\sqrt{p₁²+p₂²+ . . . +pₙ²}. “d” represents the deviation value of the electronic element with the model number, “p₁” represents a first parameter of the electronic element with the model number, “p₂” represents a second parameter of the electronic element with the model number, . . . , and “pₙ” represents a nth parameter of the electronic element with the model number.

The parameter determining module 33 determines the model number of the electronic element having the greatest deviation value in the corresponding type of the electronic elements, and further determines the parameters of the electronic element with the determined model number according to the obtained information of the electronic elements corresponding to the selected circuit diagram.

The eligible determining module 34 inputs all the determined parameters of the electronic elements with the determined model numbers into the obtained transfer function to generate a real value, and compares the real value with the reference rule corresponding to the selected circuit diagram to determine whether all of the electronic elements corresponding to the selected circuit diagram are eligible.

If the real value matches the reference rule, the eligible determining module 34 determines that all of the electronic elements corresponding to the selected circuit diagram are eligible. The display control module 35 controls the display unit 3 to display information to prompt that all of the electronic elements corresponding to the selected circuit diagram are eligible. In the embodiment, the real value matching the reference value means that the real value is between the upper threshold and the lower threshold of the target value.

If the real value does not match the reference rule, the selecting module 36 determines whether each type of the electronic elements includes the electronic element with another model number, different from the model number of the electronic element having the greatest deviation value in the corresponding type of electronic element. If any one type of the electronic element does not include the electronic element with another model number, the display control module 35 controls the display unit 3 to display information to prompt that all of the electronic elements corresponding to the selected circuit diagram are ineligible. For example, a circuit employs a resistor and a capacitor. The resistance of the resistor is 5 ohms and the capacitance of the capacitor is 10 farads. One model number of the resistor is 111111, and the other model number of the resistor is 121212. One model number of the capacitor is 131313, and the other model number of the capacitor is 141414. When the real value of the resistor with model number 111111 and the capacitor with model number 141414 does not match the reference rule, the selecting module determines that the resistor includes the resistor with another model number 121212, and the capacitor includes the capacitor with another model number 131313.

If each type of the electronic elements includes the electronic element with another model number, the cancelling module 37 determines an element deviation value according to a formula:

$$V = \frac{p \times d}{3} .$$

“V” represents the element deviation value of the electronic element; “p” represents the element value of the electronic element, and “d” represents the deviation value of the electronic element with the model number. The cancelling module 37 determines a difference value between the greatest element deviation value and the second greatest element deviation value of each type of the electronic elements. That is, the difference value is equal to the greatest element deviation value in the corresponding type of the electronic element subtracting the second greatest element deviation value in the corresponding type of electronic element. The cancelling module 37 further determines the type of the electronic element having the greatest difference value, determines the model number of the electronic element having the greatest element deviation value in the determined type of the electronic element, and cancels the information of the electronic element with the determined model number having the greatest element deviation value from the obtained information of the electronic elements, to update the obtained information of the electronic elements corresponding to the selected circuit diagram.

For example, a circuit employs a resistor with a resistance of 5 ohms and a capacitor with a capacitance of 10 farads. One model number of the resistor is 111111, and the other model number of the resistor is 121212. One model number of the capacitor is 131313, and the other model number of the capacitor is 141414. The cancelling module determines the element deviation value of the resistor with the model number 111111 and the model number 121212 are respectively 9.6 and 11, and the element deviation value of the capacitor with the model number 131313 and the model number 141414 are respectively 12 and 12.5. Thus, the cancelling module determines the difference value between the element deviation values of the resistors with two model numbers is 1.4, and determines the difference value between the element deviation values of the capacitors with two model numbers is 0.5. The cancelling module further determines the resistor with the model number 121212 has the greatest element deviation value, and cancels the information of the resistor with the model number 121212.

The parameter determining module 33 determines the model number of the electronic element including the greatest deviation value in the updated obtained information of the electronic element. The eligible determining module 34, the selecting module 36, and the cancelling module 37 accordingly executes the aforementioned operation until the display unit 3 displays that all of the electronic elements corresponding to the selected circuit diagram are eligible or displays all of the electronic elements corresponding to the selected circuit diagram are ineligible.

In the embodiment, the circuit consists of a number of sub-circuits. Each sub-circuit may need a same type of electronic elements. However, the precision of each sub-circuit may be different, thus the model number of the type of electronic elements in each sub-circuit may be different. In other words, each position of a circuit may need the electronic elements with the specific model numbers, which includes a number of electronic elements with the model number. The calculating module 32 calculates the deviation values of the electronic elements with the model numbers. The parameter determining module 33 accordingly determines the model number of the electronic elements having the greatest deviation value in the corresponding specific model numbers of the electronic elements, and determines the parameters of the electronic elements with the determined model numbers. The eligible determining module 34 accordingly inputs the determined parameters of the electronic elements with the determined model numbers. The selecting module 36 accordingly determines whether the electronic elements with each specific model numbers includes the electronic elements with another model number, different from the electronic element with the model number having the greatest deviation value in the electronic elements with the corresponding specific model numbers. The cancelling module 37 accordingly determines the element deviation value, determines a difference value between the greatest element deviation value and the second greatest element deviation value of the electronic elements with each specific model numbers, determines the electronic elements with the specific model numbers having the greatest difference value, determines the electronic element having the greatest element deviation value in the electronic element with the determined specific model numbers, and further cancels the information of the determined electronic element having the largest element deviation value from the obtained information of the electronic element.

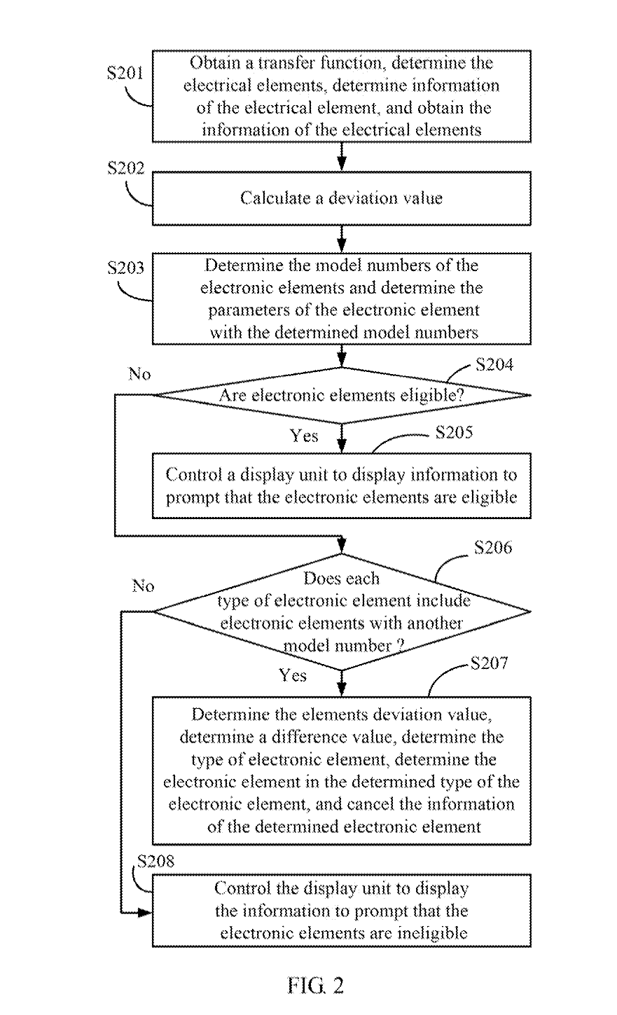

FIG. 2 shows a flowchart of an electronic element design method in accordance with an exemplary embodiment.

In step S201, the obtaining module 31 obtains a transfer function corresponding to a selected circuit diagram in response to the user operation to select a circuit diagram. The obtaining module 31 further determines the electronic elements corresponding to the selected circuit diagram, determines the information of the determined electronic elements corresponding to the selected circuit diagram in the BOM table, and obtains the information of the determined electronic elements corresponding to the selected circuit diagram corresponding to one or more selected parameters from the BOM table in response to the user operation to select one or more parameters. The parameters of the obtained information of the determined electronic elements corresponding to the selected circuit diagram only include the selected one or more parameters

In step S202, the calculating module 32 calculates a deviation value of the electronic element with the model number according to a formula: d=\sqrt{p₁²+p₂²+ . . . pₙ²}. “d” represents the deviation value of the electronic element with the model number, “p₁” represents a first parameter of the electronic element with the model number, “p₂” represents a second parameter of the electronic element with the model number, . . . , and “pₙ” represents a nth parameter of the electronic element with the model number.

In step S203, the parameter determining module 33 determines the model number of the electronic element having the greatest deviation value in the corresponding type of the electronic elements, and further determines the parameters of the electronic element with the determined model number according to the obtained information of the electronic elements corresponding to the selected circuit diagram.

In step S204, the eligible determining module 34 inputs all the determined parameters of the electronic elements with the determined model numbers into the obtained transfer function to generate a real value, and compares the real value with the reference rule corresponding to the selected circuit diagram to determine whether all of the electronic elements corresponding to the selected circuit diagram are eligible. If the real value matches the reference rule, the determining module determines that all of the electronic elements corresponding to the selected circuit diagram are eligible, the procedure goes to step S205. If the real value does not match the reference rule, the procedure goes to step S206.

In step S205, the display control module 35 controls the display unit 3 to display information to prompt that all of the electronic elements corresponding to the selected circuit diagram are eligible.

In step S206, the selecting module 36 determines whether each type of electronic element includes the electronic elements with another model number, different from the electronic element with the model number having the greatest deviation value in the corresponding type of electronic element. If each type of electronic element includes electronic elements with another model number, the procedure goes to step S207. Otherwise, the procedure goes to step S208.

In step S207, the cancelling module 37 determines an elements deviation value according to a formula:

$$V = \frac{p \times d}{3} .$$

“V” represents the elements deviation value of the electronic element; “p” represents the element value of the electronic element, and “d” represents the deviation value of the electronic element with model number. The cancelling module 37 determines a difference value between the greatest element deviation value and the second greatest element deviation value of each type of the electronic elements. The difference value is equal to the greatest element deviation value in the corresponding type of the electronic element subtracting the second greatest element deviation value in the corresponding type of electronic element. The cancelling module 37 further determines the type of the electronic element having the greatest difference value, determines the model number of the electronic element having the greatest element deviation value in the determined type of the electronic element, and cancels the information of the electronic element with the determined model number having the greatest element deviation value from the obtained information of the electronic elements, to update the obtained information of the electronic elements corresponding to the selected circuit diagram. Then, the procedure goes to step S203.

In step S208, the display control module 35 controls the display unit 3 to display information to prompt that all of the electronic elements corresponding to the selected circuit diagram are ineligible.

In this way, the electronic element design system 30 can automatically input the parameters into the transfer function, which saves manpower. Moreover, the electronic element design system 30 can cancel information of the ineligible electronic elements corresponding to the selected circuit diagram to remain the information of the eligible electronic elements, thus, the eligible electronic elements are determined, which saves time.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device connected to an input unit and a display unit, comprising:
a storage unit storing a bill of material table, a number of circuit diagrams, a number of transfer functions corresponding to the circuit diagrams, and a number of reference rules corresponding to the electronic elements; the bill of material table recording information of the electronic elements, the information of the electronic elements comprising the types of the electronic elements, the model numbers corresponding to each type of the electronic elements, and the parameters corresponding to the electronic element with each model number; each circuit diagram corresponding to one transfer function and one reference rule;
a processor;
one or more programs stored in the storage unit, executed by the processor, the one or more programs comprising:
an obtaining module operable to obtain the stored transfer function corresponding to a selected circuit diagram in response to the user operation on the input unit to select a circuit diagram, determine the electronic elements corresponding to the selected circuit diagram, determine information of the determined electronic elements corresponding to the selected circuit diagram in the stored bill of material table, and obtain the information of the determined electronic elements corresponding to the selected circuit diagram and the one or more selected parameters from the stored bill of material table in response to the user operation to select one or more parameters;
a calculating module operable to calculate a deviation value of the electronic element with a model number according to the obtained information and a formula: d=\sqrt{p₁²+p₂²+ . . . pₙ²}; “d” represents a deviation value of the electronic element with the model number, “p₁” represents a first parameter of the electronic element with the model number, “p₂” represents a second parameter of the electronic element with the model number, . . . , and “pₙ” represents a nth parameter of the electronic element with the model number;
a parameter determining module operable to determine the model number of the electronic element having the greatest deviation value in the corresponding type of the electronic elements, and further determine the parameters of the electronic element with the determined model number according to the obtained information of the electronic elements corresponding to the selected circuit diagram;
an eligible determining module operable to input all the determined parameters of the electronic elements with the determined model numbers into the obtained transfer function to generate a real value, and compare the real value with a stored reference rule corresponding to the selected circuit diagram to determine whether all of the electronic elements corresponding to the selected circuit diagram are eligible; and
a display control module operable to control the display unit to display information to prompt that all of the electronic elements corresponding to the selected circuit diagram are eligible when the real value matches the stored reference rule corresponding to the selected circuit diagram.

2. The electronic device as described in claim 1, further comprising a selecting module, wherein the selecting module is operable to determine whether each type of the electronic elements comprises the electronic element with another model number, different from the electronic element with the model number having the greatest deviation value in the corresponding type of the electronic elements; the display control module is operable to control the display unit to display information to prompt that all of the electronic elements corresponding to the selected circuit diagram are ineligible when any one type of the electronic element does not comprise the electronic element with another model number, different from the electronic element with the model number having the greatest deviation value in the corresponding type of electronic element.

3. The electronic device as described in claim 2, further comprising a cancelling module, wherein when each type of the electronic element comprises the electronic element with another model number, the cancelling module is operable to:
determine an element deviation value according to a formula:
$$V = \frac{p \times d}{3} ;$$
“V” represents the element deviation value of the electronic element; “p” represents an element value of the electronic element, and “d” represents the deviation value of the electronic element with the model number;
determine a difference value between the greatest element deviation value and the second element deviation value of each type of the electronic elements; and
determine the type of the electronic element having the greatest difference value, determine the model number of the electronic element having the greatest element deviation value in the determined type of the electronic element, and further cancel the information of the electronic element with the determined model number having the greatest element deviation value from the information of the obtained information of the electronic elements, to update the obtained information of the electronic elements corresponding to the selected circuit diagram.

4. The electronic device as described in claim 1, wherein when each position of the circuit need specific model numbers of the type of the electronic elements,
the calculating module is operable to calculate the deviation value of the electronic elements with the model number;
the parameter determining module is operable to accordingly determine the model number of the electronic elements having the greatest deviation value in the corresponding specific model numbers of the electronic elements, and determine the parameters of the electronic elements with the determined model numbers; and
the eligible determining module is operable to accordingly input all the determined parameter of the electronic elements with the determined model numbers.

5. The electronic device as described in claim 3, wherein when each position of the circuit need specific model numbers of the type of the electronic element,
the calculating module is operable to calculate the deviation value of the electronic elements with the model number;
the parameter determining module is operable to accordingly determine the model number of the electronic elements having the greatest deviation value in the corresponding specific model numbers of the electronic elements, and determine the parameters of the electronic elements with the determined model number;
the eligible determining module is operable to accordingly input all the determined parameters of the electronic elements with the determined model number;
the selecting module is operable to accordingly determine whether the electronic elements with each specific model numbers comprises the electronic elements with another model number, different from the electronic element with the model number having the greatest deviation value in the electronic element with the corresponding specific model numbers; and
the cancelling module is operable to accordingly determine a difference value of the element deviation value between the greatest element deviation value and the second greatest element deviation value of the electronic elements with each specific model numbers, determine the electronic elements with the specific model numbers having the greatest difference value, determine the model number of the electronic element having the greatest element deviation value in the electronic elements with the determined specific model numbers, and further cancel the information of the electronic element with the determined model number having the greatest element deviation value from the obtained information of the electronic element.

6. An electronic element design method comprising:
obtaining a stored transfer function corresponding to a selected circuit diagram in response to the user operation on an input unit to select a circuit diagram, determining the electronic elements corresponding to the selected circuit diagram, determining information of the determined electronic elements corresponding to the selected circuit diagram in a stored bill of material table, and obtaining the information of the determined electronic elements corresponding to the selected circuit diagram and the one or more selected parameters from the stored bill of material table in response to the user operation to select one or more parameters; the information of the electronic elements comprising the types of the electronic element, the model numbers corresponding to each type of the electronic element, and the parameters corresponding to each model number;
calculating a deviation value of the electronic element with a model number according to the obtained information and a formula: d=\sqrt{p₁²+p₂²+ . . . +pₙ²}; “d” represents a deviation value of the electronic element with the model number, “p₁” represents a first parameter of the electronic element with the model number, “p₂” represents a second parameter of the electronic element with the model number, . . . , and “pₙ” represents a nth parameter of the electronic element with the model number;
determining the model number of the electronic element having the greatest deviation value in the corresponding type of the electronic elements, and further determining the parameters of the electronic element with the determined model number according to the obtained information of the electronic elements corresponding to the selected circuit diagram;
inputting all the determined parameters of the electronic elements with the determined model numbers into the obtained transfer function to generate a real value, and comparing the real value with a stored reference rule corresponding to the selected circuit diagram to determine whether all of the electronic elements corresponding to the selected circuit diagram are eligible; and
controlling a display unit to display information to prompt that all of the electronic elements corresponding to the selected circuit diagram are eligible when the real value matches the stored reference rule corresponding to the selected circuit diagram.

7. The electronic element design method as described in claim 6, wherein the method further comprises:
determining whether each type of the electronic elements comprises the electronic element with another model number, different from the electronic element with the model number having the greatest deviation value in the corresponding type of the electronic elements; and
controlling the display unit to display information to prompt that all of the electronic elements corresponding to the selected circuit diagram are ineligible when any one type of the electronic element does not comprise the electronic element with another model number, different from the electronic element with the model number having the greatest deviation value in the corresponding type of electronic element.

8. The electronic element design method as described in claim 7, wherein the method further comprises:
determining an element deviation value according to a formula when each type of the electronic element comprises the electronic element with another model number:
$$V = \frac{p \times d}{3} ;$$
“V” represents the element deviation value of the electronic element; “p” represents an element value of the electronic element, and “d” represents the deviation value of the electronic element with the model number;
determining a difference value between the greatest element deviation value and the second element deviation value of each type of the electronic elements; and
determining the type of the electronic element having the greatest difference value, determining the model number of the electronic element having the greatest element deviation value in the determined type of the electronic element, and further cancelling the information of the electronic element with the determined model number having the greatest element deviation value from the information of the obtained information of the electronic elements, to update the obtained information of the electronic elements corresponding to the selected circuit diagram.

9. The electronic element design method as described in claim 6, each position of the circuit need specific model numbers of the type of the electronic element, wherein the method further comprises:
calculating the deviation value of the electronic elements with the model number;
accordingly determining the model number of the electronic elements having the greatest deviation value in the corresponding specific model numbers of the electronic elements, and determining the parameters of the electronic elements with the determined model numbers; and
accordingly inputting all the determined parameter of the electronic elements with the determined model numbers.

10. The electronic element design method as described in claim 8, each position of the circuit need specific model numbers of the type of the electronic element, wherein the method further comprises:
calculating the deviation value of the electronic elements with the model number;
accordingly determining the model number of the electronic elements having the greatest deviation value in the corresponding specific model numbers of the electronic elements, and determining the parameters of the electronic elements with the determined model number;
accordingly inputting all the determined parameters of the electronic elements with the determined model number;
accordingly determining whether the electronic elements with each specific model numbers comprises the electronic elements with another model number, different from the electronic element with the model number having the greatest deviation value in the electronic element with the corresponding specific model numbers; and
accordingly determining a difference value of the element deviation value between the greatest element deviation value and the second greatest element deviation value of the electronic elements with each specific model numbers, determining the electronic elements with the specific model numbers having the greatest difference value, determining the model number of the electronic element having the greatest element deviation value in the electronic elements with the determined specific model numbers, and further cancelling the information of the electronic element with the determined model number having the greatest element deviation value from the obtained information of the electronic element.

11. A storage medium storing a set of instructions, the set of instructions capable of being executed by a processor of an electronic device, causing the electronic device to perform an electronic element assign method, the method comprising:
obtaining a stored transfer function corresponding to a selected circuit diagram in response to the user operation on an input unit to select a circuit diagram, determining the electronic elements corresponding to the selected circuit diagram, determining information of the determined electronic elements corresponding to the selected circuit diagram in a stored bill of material table, and obtaining the information of the determined electronic elements corresponding to the selected circuit diagram and the one or more selected parameters from the stored bill of material table in response to the user operation to select one or more parameters; the information of the electronic elements comprising the types of the electronic element, the model numbers corresponding to each type of the electronic element, and the parameters corresponding to each model number;
calculating a deviation value of the electronic element with a model number according to the obtained information and a formula: d=\sqrt{p₁²+p₂²+ . . . +pₙ²}; “d” represents a deviation value of the electronic element with the model number, “p₁” represents a first parameter of the electronic element with the model number, “p₂” represents a second parameter of the electronic element with the model number, . . . , and “pₙ” represents a nth parameter of the electronic element with the model number;
determining the model number of the electronic element having the greatest deviation value in the corresponding type of the electronic elements, and further determining the parameters of the electronic element with the determined model number according to the obtained information of the electronic elements corresponding to the selected circuit diagram;
inputting all the determined parameters of the electronic elements with the determined model numbers into the obtained transfer function to generate a real value, and comparing the real value with a stored reference rule corresponding to the selected circuit diagram to determine whether all of the electronic elements corresponding to the selected circuit diagram are eligible; and
controlling a display unit to display information to prompt that all of the electronic elements corresponding to the selected circuit diagram are eligible when the real value matches the stored reference rule corresponding to the selected circuit diagram.

12. The storage medium as described in claim 11, wherein the method further comprises:
determining whether each type of the electronic elements comprises the electronic element with another model number, different from the electronic element with the model number having the greatest deviation value in the corresponding type of the electronic elements; and
controlling the display unit to display information to prompt that all of the electronic elements corresponding to the selected circuit diagram are ineligible when any one type of the electronic element does not comprise the electronic element with another model number, different from the electronic element with the model number having the greatest deviation value in the corresponding type of electronic element.

13. The storage medium as described in claim 12, wherein the method further comprises:
determining an element deviation value according to a formula when each type of the electronic element comprises the electronic element with another model number:
$$V = \frac{p \times d}{3} ;$$
“V” represents the element deviation value of the electronic element; “p” represents an element value of the electronic element, and “d” represents the deviation value of the electronic element with the model number;
determining a difference value between the greatest element deviation value and the second element deviation value of each type of the electronic elements; and
determining the type of the electronic element having the greatest difference value, determining the model number of the electronic element having the greatest element deviation value in the determined type of the electronic element, and further cancelling the information of the electronic element with the determined model number having the greatest element deviation value from the information of the obtained information of the electronic elements, to update the obtained information of the electronic elements corresponding to the selected circuit diagram.

14. The storage medium as described in claim 11, each position of the circuit need specific model numbers of the type of the electronic element, wherein the method further comprises:
calculating the deviation value of the electronic elements with the model number;
accordingly determining the model number of the electronic elements having the greatest deviation value in the corresponding specific model numbers of the electronic elements, and determining the parameters of the electronic elements with the determined model numbers; and
accordingly inputting all the determined parameter of the electronic elements with the determined model numbers.

15. The storage medium as described in claim 13, each position of the circuit need specific model numbers of the type of the electronic element, wherein the method further comprises:
calculating the deviation value of the electronic elements with the model number;
accordingly determining the model number of the electronic elements having the greatest deviation value in the corresponding specific model numbers of the electronic elements, and determining the parameters of the electronic elements with the determined model number;
accordingly inputting all the determined parameters of the electronic elements with the determined model number;
accordingly determining whether the electronic elements with each specific model numbers comprises the electronic elements with another model number, different from the electronic element with the model number having the greatest deviation value in the electronic element with the corresponding specific model numbers; and
accordingly determining a difference value of the element deviation value between the greatest element deviation value and the second greatest element deviation value of the electronic elements with each specific model numbers, determining the electronic elements with the specific model numbers having the greatest difference value, determining the model number of the electronic element having the greatest element deviation value in the electronic elements with the determined specific model numbers, and further cancelling the information of the electronic element with the determined model number having the greatest element deviation value from the obtained information of the electronic element.
